(19) United States
(12) Patent Application Publication
(10) Pub. No.: US 2015/0202565 A1
(43) Pub. Date: Jul. 23, 2015

(54) Smart Air Purification System for Enclosed Living Spaces

(71) Applicants: Xiwang Qi, Scottsdale, AZ (US); Mei Jiang, Scottsdale, AZ (US)

(72) Inventors: Xiwang Qi, Scottsdale, AZ (US); Mei Jiang, Scottsdale, AZ (US)

(21) Appl. No.: 14/599,469

(22) Filed: Jan. 17, 2015

Related U.S. Application Data
(60) Provisional application No. 61/929,063, filed on Jan. 19, 2014.

(51) Int. Cl. B01D 53/34; B01D 53/02; B01D 53/86

(52) U.S. Cl. CPC B01D 53/346; B01D 53/8696; B01D 53/02; B01D 2257/708; B01D 2257/7022; B01D 2257/7027; B01D 2257/502; B01D 2257/404; B01D 2257/302

(57) ABSTRACT

This invention is related to a smart air purification system for indoor and in-vehicle air cleaning, capable of eliminating gaseous toxic chemicals, hazardous airborne particles and unpleasant odors. The system consists of particle filter, toxic chemical and odor absorber, particle and chemical pollutant gas sensors, and a smart control unit with internet-enabled data terminal connected with user's smart devices via Wi-Fi or cellular 3G and 4G LTE.

### CROSS-REFERENCE TO RELATED APPLICATION

This application claims priority of Provisional Application Ser. No. 61/929,063 filed in the United States Patent and Trademark Office on Jan. 19, 2014, and which addresses the same subject matter.

### FIELD OF THE INVENTION

This invention is related to a smart air purification system used for indoor and in-vehicle air cleaning, capable of eliminating toxic chemical pollutants, hazardous airborne particles and unpleasant odors. The system is equipped with particle filter, toxic chemical and odor absorber, particle and toxic gas sensors, air quality indicators, and an internet- enabled data terminal and control unit which is connected to mobile smart devices such as smartphones and is able to alert users about unhealthy levels of indoor air pollutants. The users can view the indoor air quality data in real-time and send operational instructions to prep the vehicles or rooms with refreshed air as needed.

### BACKGROUND OF THE INVENTION

People spend the majority of their time in vehicles and rooms where they are constantly exposed to vehicle engine exhaust, diesel and gasoline fumes, gas furnace and stove emissions and various chemicals emitted from vehicle interiors, furniture and other household items (foam insulation, rubber, plastics, carpet, sofa, mattress, wallboard, wallpapers, plywood, glues, adhesives, paints, sprays, cleaners, pesticides, solvents, greases). US EPA estimates Indoor air pollution is two to five times worse (sometimes a 100× worse) than the air outdoors. These indoor air pollutants often include very toxic chemical gases such as carbon monoxide, nitrogen oxide, ammonia, sulfur dioxide, hydrogen sulfide, chlorine, propene, acetone, formaldehyde, butadiene, benzene, toluene, xylene, etc. These chemicals can easily accumulate to higher concentrations within enclosed spaces and cause permanent damage to the lungs, liver, brain and other body systems, especially harmful to vulnerable infants, children, elderly and sick people. For example, benzene, a known cause of leukemia, is often found in new carpets; formaldehyde, classified as human carcinogen by the International Agency for Research on Cancer, is often used in insulation foam, disinfectants and pressed wood kitchen cabinets. 1,3-butadiene, often found in automobile exhaust and cigarette smoke, is also listed as a known carcinogen by the Agency for Toxic Substances Disease Registry and the US EPA. Clearly there is a need to tackle this indoor air pollution problem with an effective and efficient system.

### DESCRIPTION OF THE PRIOR ART

Common way to clean the indoor air is through air filters, such as various air purifiers on the market which employed HEPA filters to trap airborne particles such as dust, pollen and bacteria. However, such practice does not eliminate toxic gaseous chemical molecules from the air, such as formaldehyde, butadiene, benzene, carbon monoxide, nitrogen oxide, sulfur dioxide, etc., which in reality impose bigger health threats to people than particular matters. U.S. Pat. No. 6,280,691 described a system combining HEPA filter with an oxidation catalyst to deal with the gaseous chemical contaminates, but a heat exchanger is needed to heat up the inlet air in order for the catalyst to work, which has potential fire hazard in the living environment. U.S. Pat. Nos. 8,124,012 and 8,778,272 both used UV radiation and photo-catalyst system to deal with the volatile organic compounds, but the safety concern of UV radiation and the system complexity is prohibiting their practical uses in living environment.

In recent years, smart-home products have become the new trend for the consumer appliance market. For example, Start-up Nest launched smart thermostat and smart carbon monoxide detector. At the 2014 CES Samsung demoed a Smart Home system which involved a robotic vacuum cleaner, refrigerator, washing machine, air conditioner, smart TV, and mounted camera, all using Galaxy gear as the central control system. Since then, more smart home devices emerged such as locks, security monitoring, lighting and entertainment systems. As air quality is an essential part of smart home lifestyle, there is a clear need in the market for a smart air purification system that is able to remove both air-borne particles and toxic gaseous chemicals from enclosed spaces, and also connected with smart devices in real time to allow owners to remotely view and control the indoor air quality and prepare the rooms or vehicles in advance.

### SUMMARY OF THE INVENTION

This invention is related to a smart air purification system for indoor and in-vehicle air cleaning, capable of eliminating gaseous toxic chemicals, hazardous airborne particles and unpleasant odors. It comprised of following functional units: 1) A cleaning unit, consisting of a particle filter, a toxic chemical absorber made of nano-structured composite material, and an air intake fan; 2) A sensor and display unit, consisting of a particle sensor, a chemical gas sensor and a multi-color LED air quality indicator; 3) A smart control unit with internet enabled data terminal which stores air quality data, controls operations, and communicates with owners' smart devices; 4) A power supply unit with battery and DC/AC power connector. The system is able to alert users about unhealthy levels of indoor air pollutants. The users can view the indoor air quality data in real-time and send operational instructions to prep the vehicles or rooms with refreshed air as needed.

### DETAILED DESCRIPTION OF THE INVENTION

This invention is related to a smart indoor and in-vehicle air purification system, which consists of a cleaning unit, a sensor/display unit, a smart control unit with internet enabled data terminal for data processing, storage and communication with smart devices, and a power supply unit.

The cleaning unit consists of two different functional sections: a) a HEPA rated particle filter located on the upstream section of the device, for trapping fine particles down to 0.3 um, including PM 2.5; b) a chemical pollutant and odor absorber located on the downstream of the device, made of nano-structured composite material for absorbing toxic gaseous chemicals and unpleasant odors. The nano-structured composite material comprises nano-porous carbon, zeolites with sub nano-size pores and at least 1 other component chosen from nano-porous rare earth oxides and nano-sized catalysts. The composite material is nano-engineered and formulated to create enormous absorbing surface area that can trap a wide range of indoor chemical pollutants, such as formaldehyde, butadiene, benzene, carbon monoxide, nitrogen oxide, etc., as well as all kinds of unpleasant odors The gas absorption efficiency is further enhanced by convection air flow through the channels of porous composite structure created by a stage or stage-less speed variation motor fan located either before the particle filter or after. The fan creates a forced air flow into the particle filter first. The filtered air then travels down to the chemical and odor absorber and the toxic gaseous chemicals and odors are trapped in the nano-structured composite material surface. The cleaned air exits from the absorber and flows back into the living space.

One embodiment in making the chemical absorber is by mixing activated carbon, zeolite and rare earth oxides powders together into a slurry, or by mixing liquid form carbon precursors with zeolite and rare earth oxides into a slurry, followed by extrusion or tape-casting or molding to forms of various shapes, then followed by drying, carbonizing and activation of the mixture materials into highly porous composite material. The nano-structured composite material is made into integrated form with high geometric surface and low air flow resistance for high trapping efficiency, by either extrusion into honeycomb like monolith; or by tape-casting into sheets and laminating into corrugated stacks; or by rolling sheets into round cylinder shapes; or by molding into various shapes, such as cylinder, cube, or hexagonal prism with internal intrinsic porous structure. Another embodiment to make the chemical absorber is by dipping porous ceramic parts such as ceramic foams and honeycomb ceramic monolith substrates in liquid form carbon precursors, followed by drying, carbonizing and activation, forming into porous monolith carbon structure, which is further coated with zeolites and rare earth oxides to form the nano-structured composite. The physical configuration of chemical absorber as a whole takes the shape of round or oval cylinders, or rectangular prism, with an aspect ratio of 0.3 to 3, preferably of 0.5 to 2, which is the ratio of geometric average of cross-section dimension to the height along the air flow direction. There are at least 100 open-ended channels per square inch in the absorber cylinder or rectangular prism. Such a design gives tremendous geometric surface area and much longer air residential time for trapping pollutants as compared to traditional air purifiers. The liquid carbon precursors can be polymer resin, such as phenolic resin, Furan resin, etc. The zeolite is chosen from 3A, 4A, 5A and 13X, and Beta, Pentasil, Mordenite zeolites, etc. The rare earth oxide is chosen from yttrium oxide, lanthanum oxide, cerium oxide, praseodymium oxide, samarium oxide, and rare earth doped oxides, such as yttria-zirconia and ceria-zirconia. The nano-sized catalyst, which is used to facilitate the speed and efficiency of trapping and elimination of gaseous pollutants, is chosen from Fe, Co, Ni, Cu, Zn, Mn, Na, K, Ti, Pt, Pd, Rh, Ag, Ru, Ce and their corresponding metal oxides, which can be added either in the slurry or on individual support including carbon, zeolite and rare earth oxides.

The sensor/display unit consists of multiple components, include one on-board particle sensor, one chemical gas sensor and multi-color LED air quality indicator. The on-board particle sensor is chosen from light scattering, beta ray attenuation or polymer membrane based PM counting technologies. The chemical gas sensor is based on electrochemical or photoionized sensing mechanism, able to detect multiple gases, such as carbon monoxide, sulfur dioxide, nitrogen dioxide, formaldehyde, benzene, etc. The sensors automatically detect air pollutant levels over time in the enclosed atmosphere and send the data to the internet-enabled data terminal. At the same time, the LED air quality indicator displays different colors according to the air quality classification.

The smart control unit with internet- enabled data terminal has functions of data storage, processing, communication with smart devices and operation control. Once the detected pollutant level exceeds the preset unhealthy limit, the device will automatically start to run and also send an alert message to user's smart devices, such as mobile smartphone. The data terminal also gathers the data from on-board sensors to monitor the usage life of the particle filter and chemical gas absorber and alert the user to change the filter and absorber core material as needed. On the other hand, users can remotely retrieve air quality data, change operational settings and send instruction to the device via mobile communication channels like Wi-Fi and cellular 3G and 4G LTE.

The power supply unit has a rechargeable battery pack, such as li-ion battery, and a DC/AC plugging cord, which has the flexibility to plug in the 12V car cigarette lighter receptacle or household 110/220V AC outlet.

1. A smart air purification system for indoor and in-vehicle air cleaning, comprising:
a. an air cleaning unit, consisting of a particle filter, a gaseous chemical pollutant and odor absorber, and a motor fan for forced air circulation through the cleaning unit, capable of eliminating toxic chemical indoor pollutants including, but not limited to formaldehyde, butadiene, benzene, toluene, xylene, carbon monoxide, nitrogen oxides, sulfur dioxide, as well as hazardous airborne particles and unpleasant odors in the enclosed spaces.
b. a sensing/display unit, consisting of a particle sensor, a chemical pollutant gas sensor and multi-color LED air quality indicator.
c. an smart control unit, consisting of internet-enabled data terminal and microprocessor, capable of gathering and storing the air quality data from sensors, processing the data or instructions received and controlling the cleaning unit operations, monitoring the usage life of particle filter and chemical pollutant absorber, and communicating with users' smart devices like smartphones via mobile communication channels such as Wi-Fi and cellular 3G/4G LTE.
d. a power supply unit, with rechargeable battery pack and AC/DC external plugging cord.

2. The air cleaning unit according to claim 1, wherein said particle filter is HEPA rated, made of borosilicate glass fibers or synthetic plastic fibers, such as polyethylene, polypropylene and polyester, capable of capturing air-borne dust, allergens, pet dander, smoke particles, bacteria, including PM10 and PM2.5.

3. The air cleaning unit according to claim 1, wherein said chemical pollutant and odor absorber is made of nano-structured composite material for absorbing toxic gaseous chemicals and unpleasant odors. The nano-structured composite material comprises nano-porous carbon, zeolites with sub nano-size pores and at least 1 other component chosen from nano-porous rare earth oxides and nano-sized catalysts.

4. The air cleaning unit according to claim 3, wherein said nano-porous carbon is activated carbon with specific surface area from 800 m²/g to 3500 m²/g.

5. The air cleaning unit according to claim 3, wherein said zeolite is selected from zeolite 3A, 4A, 5A, zeolite 13X, zeolite Beta, Pentasil and Mordenite, and combinations thereof.

6. The air cleaning unit according to claim 3, wherein said rare earth oxide is chosen from yttrium oxide, lanthanum oxide, cerium oxide, praseodymium oxide, samarium oxide, and rare earth doped oxides, such as yttria-zirconia and ceria-zirconia, and combinations thereof.

7. The air cleaning unit according to claim 3, wherein said nano-sized catalyst is selected from a group consisting of iron, cobalt, nickel, copper, zinc, manganese, sodium, potassium, titanium, platinum, palladium, rhodium, ruthenium, silver, cerium, their corresponding oxides, and combinations thereof.

8. The air cleaning unit according to claim 1, wherein said chemical pollutant and odor absorber is made into the form of sponge-like foam, or roll-up corrugated sheets, or honeycomb monolith, with interconnected porous structure and air flow channels.

9. The air cleaning unit according to claim 1, wherein said chemical pollutant and odor absorber is made into shape of round or oval cylinder, or rectangular prism, with an aspect ratio in the range of 0.3 to 3, defined as the ratio of cross-section diameter or equivalent diameter to the height.

10. The chemical pollutant and odor absorber according to claim 9, wherein said round or oval cylinder or rectangular prism has multiple open-ended channels running along its height direction for air flowing in and out.

11. The chemical pollutant and odor absorber according to claim 9, wherein said round or oval cylinder or rectangular prism has at least 100 channels per square inch.
